(19) United States
(12) Patent Application Publication
(10) Pub. No.: US 2008/0141141 A1
(43) Pub. Date: Jun. 12, 2008

(54) WIDGET RUNTIME ENGINE FOR ENTERPRISE WIDGETS

(76) Inventors: Dennis B. Moore, Hillsborough, CA (US); Denis J. Browne, San Mateo, CA (US); Eric R.B. Wood, Menlo Park, CA (US); Frederic Samson, Wayne, PA (US)

Correspondence Address: SAP/BLAKELY, 1279 OAKMEAD PARKWAY, SUNNYVALE, CA, 94085-4040, US

(21) Appl. No.: 11/867,655

(22) Filed: Oct. 4, 2007

Related U.S. Application Data
(60) Provisional application No. 60/873,869, filed on Dec. 7, 2006.

(51) Int. Cl. G06F 3/048

(52) U.S. Cl. 715/748

(57) ABSTRACT

An Enterprise widget interface in a computing device that receives input from a portable logic module soliciting operations from a backend server separate from the computing device, sends requests to the backend server to execute the operation and receives responses from the backend server including data related to the execution of the operation. The Enterprise widget interface further sends the response related data to the portable logic module for rendering via a computing interface connected with the computing device.

### RELATED APPLICATION

This U.S. Patent Application claims the benefit of priority of U.S. Provisional Application 60/873,869 filed Dec. 7, 2006.

### TECHNICAL FIELD

Embodiments of the invention relate to the field of end-user applications, and more particularly, to an Enterprise widget interface to enable a desktop widget to access a backend server separate from the computing device on which the desktop widget executes.

### BACKGROUND

Historically, “widgets” have been used to provide simple user applications having a narrowly defined scope of functionality and a dedicated purpose. Generally, historical widgets are visually contained within their own dedicated window and are capable of being repositioned on a computer's graphical user interface (“GUI”) desktop environment. Several well known historical widgets include “googly eyes,” which came standard with X11 windowing environments on many UNIX platforms and whose function was to peer in the direction of the cursor; analog and digital clocks that were commonly placed on a desktop merely for displaying the time; and cursor absolute position displays that converted the absolute position of a cursor to its numerical (x,y) coordinates equivalent for reference by the user.

In recent years, game widgets have been developed allowing users to play simple games inside a small widget container, examples of which include tic-tac-toe, hangman, and sudoku. Other widgets have been developed in recent times allowing a user to pull data from Internet sources not protected by firewalls or Enterprise level security protection. Examples include weather widgets that are dedicated to retrieving a brief weather forecast for a specific zip-code and mortgage rate widgets that display daily mortgage rates. In the case of the weather widget and the mortgage rate widget, the information source is an unsecured server located on the Internet and the information is retrievable by anyone without the use of security credentials or the necessity to traverse Enterprise level security schemes.

Traditional widgets have no means to interact with backend servers within an Enterprise computing environment. Connecting applications of any size with the backend servers of an Enterprise computing environment is technically complex and the means for doing so have been dependent on the environment itself. Because of this technical complexity, historical widgets have been relegated to small, simple tasks that require only the immediate resources locally available to the widget through its host operating system. Conversely, tasks that require data from a backend Enterprise server are customarily programmed into specialized feature rich applications architected specifically for the needs of end users requiring Enterprise backend data. The resulting applications initially suit the needs of the users well. Unfortunately, because the feature rich application is highly dependent upon the environment on which it was built, it is not easily portable to other environments, nor is the application easily modifiable to suit the changing needs of the end users. Over time, as the needs of the end-users change, the traditional feature-rich application cannot accommodate the evolving needs of its users and becomes more and more antiquated, until eventually deemed obsolete and replaced by a new, expensive and complex feature-rich application.

### BRIEF DESCRIPTION OF THE DRAWINGS

The claims set forth the embodiments of the invention with particularity. Certain embodiments of the invention, together with its advantages, may be understood from the following detailed description taken in conjunction with the accompanying drawings. Embodiments of the invention are illustrated by way of example and not by way of limitation in the Figures of the accompanying drawings. It should be noted that references to “an,” “one,” “another,” “alternative,” or a “particular” embodiment in this disclosure are not necessarily referring to the same embodiment, although they may be, and such references mean at least one embodiment. Reference numerals are utilized herein to identify corresponding components of the Figures described below. Components corresponding to like reference numerals in multiple Figures represent like elements.

FIG. 1 illustrates an apparatus for communicating information between Enterprise widgets and backend systems within an Enterprise backend environment via an Enterprise widget interface, according to one embodiment.

FIG. 2 illustrates an Enterprise widget interface transmitting information between an Enterprise widget and a backend Enterprise server according to a particular embodiment.

FIG. 3 illustrates a method at an Enterprise widget interface that receives input from a portable logic module, sends and receives information from a backend Enterprise system, and forwards information back to the portable logic module responsive to the input according to another embodiment.

### DETAILED DESCRIPTION

An Enterprise widget interface as described herein can receive input from an Enterprise widget or Portable Logic Module (“PLM”) soliciting an operation of that requires access to data stored in a backend Enterprise server, and send a request to the backend Enterprise server requesting execution of the operation, receive a response back from the backend Enterprise server which has data related to the execution of the operation, and send a representation of the data received at the Enterprise widget interface to the computing device via the Enterprise widget for rendering by the computer interface.

A simple scenario illustrating such a system is that of an Enterprise employee who desires to know the inventory level of a given part, for example, a picture frame. In one embodiment, the Enterprise employee selects from a multitude of simplistic, small, dedicated PLMs, each having access to a specific subset of Enterprise data housed on backend Enterprise systems. The Enterprise employee downloads a PLM named “Single Part Inventory Lookup,” whose sole functionality is to gain access through the secure Enterprise environment, to a specific backend Enterprise server housing data pertaining to the inventory level of a given part. The Enterprise employee executes the PLM on a computing device and is presented with a small window displaying a representation of the PLM downloaded. The Enterprise employee types a description of a part or a part number into the appropriate text entry box and submits the data. The Enterprise employee need not know the name or location of the Enterprise backend system that has access to the desired data, nor does the Enterprise employee need to know the necessary security protocols required to gain access to the Enterprise backend system through the secure Enterprise environment. However, even without such knowledge the Enterprise employee is presented with an updated representation of the PLM depicting the desired data, in response to his input or request. In particular, the PLM representation displays the total quantity of picture frames available in inventory for the Enterprise.

The PLM downloaded by the Enterprise employee accesses data stored in backend Enterprise systems via an Enterprise widget interface which has access to all the business logic necessary to determine which Enterprise system should be contacted to acquire the data requested by the user, and further includes the appropriate facilities to gain access to the Enterprise backend systems through the secure Enterprise environment. The Enterprise widget interface may contain a variety of attributes that, among other things, allow it to be configured to automatically grant access to an Enterprise widget based on a wide array of environmental variables. Here, the Enterprise widget interface determined via the environment on which it was executing that the Enterprise widget's user was pre-authorized to have access to the data, and therefore did not subject the user to further authentication. In alternative embodiments, or if the user were attempting to access the data from an environment having not been pre-authorized, the same Enterprise widget interface would prompt the user for authentication or simply reject the user's request, based upon the attributes reflecting the operating environment of the Enterprise widget interface or the Enterprise widget.

As used herein, a portable logic module or “PLM” refers to an application characterized by its limited and specific functionality relative to traditional feature rich applications. PLMs are further characterized by their visually small size in relation to a graphical user interface (“GUI”) desktop environment or the visual representation of a typical application executing on such a desktop environment. While a typical feature rich application in active use, such as a web-browser or a word-processor, normally consumes the majority of a full sized display, such as a 17 graphical display monitor, the typical PLM consumes less than 20% of the same two-dimensional space of a full sized display.

PLMs may also be referred to as “business widgets,” “Enterprise widgets,” or simply “widgets” or “gadgets.” Those having ordinary skill in the art will appreciate that a PLM is not a traditional full feature application. For example, the World Wide Consortium (“W3C”) defines widgets as:

[U]sually small client-side applications for displaying and updating remote data, packaged in a way to allow a single download and installation on a client machine. The widget may execute outside the typical web browser interface. Examples include clocks, stock tickers, news casters, games and weather forecasters. Some existing industry solutions go by the names ‘widgets,’‘gadgets’ or ‘modules.’

See World Wide Consortium, Widgets 1.0 (W3C Working Draft 9, Nov. 2006). This W3C definition appropriately defines the class of applications referred to herein as PLMs or enterprise widgets, with the distinction that the PLMs, Enterprise widgets, and business widgets as described herein are able to communicate with backend servers protected by a secured network within an Enterprise backend environment through the use of an Enterprise widget interface as disclosed herein.

Lastly, in the computer arts, the term “widget” is sometimes used to refer to the graphical components of a GUI, such as sliders, buttons, checkboxes, and dropdowns. This definition is not an appropriate characterization of widgets as used herein.

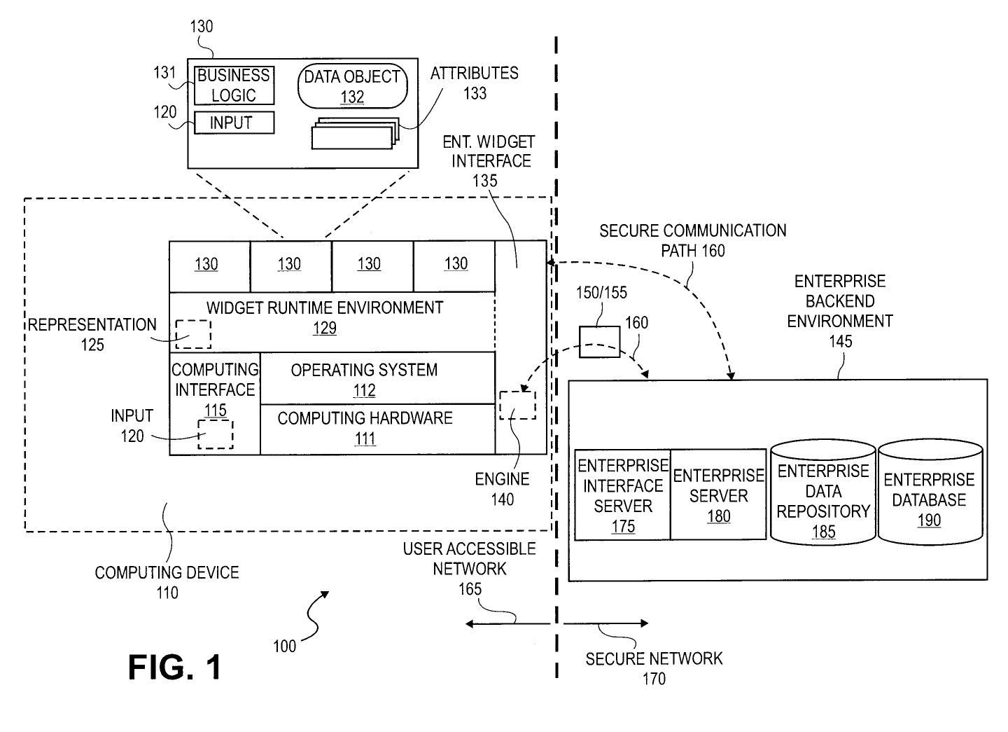

Refer now to FIG. 1 illustrating apparatus 100 to communicate information between Enterprise widgets and backend systems within an Enterprise backend environment via Enterprise widget interface 135.

Computing device 110 contains computing interface 115 which can display output on behalf of computing device 110 and receive input 120 on behalf of computing device 110. Computing device 110 further contains computing hardware 111 and operating system 112. Widget runtime environment 129 runs on computing device 110, supported by operating system 112 and computing hardware 111. Widget runtime environment 129 supports multiple PLMs 130. Each PLM contains business logic 131 to store instructions particular to a given PLM's 130 function, data object 132 (e.g. to store data, configuration parameters, and variables describing PLM 130, Enterprise widget, or Enterprise widget interface 135), and attributes 133 to store environmental parameters, state and status data, and further configuration information. Each PLM 130 can receive input 120 via computing interface 115. Enterprise widget interface 135 is connected with widget runtime environment 129 and supported by operating system 112 and computing hardware 111 within computing device 110.

Computing device 110 operates within user accessible network 165 and communicates with systems within Enterprise backend environment 145 via Enterprise widget interface 135 and its components, such as engine 140. Enterprise backend environment 145 operates within secure network 170 and is connected with Enterprise widget interface 135 via secure communication path 160. Enterprise widget interface 135 transmits data, such as requests 150 and responses 155 via secure communication paths 160. Enterprise backend environment 145 contains Enterprise interface server 175, Enterprise server 180, Enterprise data repository 185, and Enterprise database 190, all protected by the Enterprise security schemes of secure network 170.

Computer interface 115 may be any electronic device capable of receiving input 120. Common examples include human interface input devices, pointing input devices (e.g. a mouse or stylus), key input devices (e.g. a keyboard or keypad), touch screen input devices, optical input devices, etc. Furthermore, computing interface 115 may be any electronic device capable of conveying representation 125 of output from computing device 110 including Video Graphics Array (“VGA”) monitors, Liquid Crystal Display (“LCD”) monitors, televisions, Personal Digital Assistant (“PDA”) display screens, audio speakers, computer printers, etc. The term “representation” refers to any manner in which information or data may be conveyed by electronic means. Common examples of such representations include textual representations, graphical representations, and audible representations.

In one embodiment, computing device 110 is a personal computer (“PC”) connected with computing interface 115, computing interface 115 includes a “mouse” that captures a user's motions, a keyboard input device, and a computer display monitor. In an alternative environment, the computing device is a personal digital assistant (“PDA”) connected with computing interface 115; computing interface 115 includes a stylus, a touch sensitive screen that captures input 120, and a display integrated with the touch sensitive screen.

Computing device 110 is communicatively coupled with portable logic module (“PLM”) via an internal bus. PLM 130 may operate on the native graphical desktop of operating system 112, or PLM 130 may operate within widget-runtime-environment 129. Examples of widget-runtime-environments 129 include Yahoo! Widget Engine™, Apple Macintosh Dashboard™, and Microsoft Windows Vista Gadgets™. Trademarks are the property of their respective owners and are used herein solely for the purposes of identification. PLMs 130 may be created through the use of application development environments, widget development environments, and distributed-application development environments known in the art.

PLM 130 can receive input 120 from computing interface 115 soliciting an operation from PLM 130. Input 120 refers to any data, information, signal, indicator, variable, or value provided to PLM 130. Examples of input 120 include text, sound, images, selections (e.g. clicking on a check box or radio button), and telemetry data from electronic sensors (e.g. vibration, temperature, elevation, and acceleration data).

PLM 130 can interface with Enterprise widget interface 135 directly, or interface with Enterprise widget interface 135 through widget runtime environment 129, or through operating system 112. Enterprise widget interface 135 may optionally include engine 140 as shown in FIG. 1. Engine 140 is capable of receiving input 120 from PLMs 130 and sending request 150 to backend Enterprise server 180 via secure communication path 160. Secure communication path 160 may be of any type including wireless, wired, Ethernet, fiber optic, etc.

Engine 140 is further capable of receiving response 155 from backend Enterprise server 180 with data responsive to request 150 sent previously. In one embodiment, the functions of receiving input 120 from PLM 130, sending requests 150, and receiving responses 155 all happen within engine 140. In another embodiment, the functions of receiving input 120, sending requests 150, and receiving responses 155 take place within Enterprise widget interface 125, but not inside of engine 140. Additional operations or some other combination of operations may occur inside or outside of engine 140.

Backend Enterprise server 180 is a machine, computer, system, or application that processes, stores, or retrieves data for an application on the “front-end.” Backend servers 180 do not interact directly with end-users, but rather interact via machine to machine (“M2M”) communications with various clients (e.g. front-end applications or systems), such as portable logic module 130 via Enterprise widget interface 135 as described herein. As used herein, a front-end application is one with which a user can directly interface, while a backend system is not directly interfaced by the user. Rather, backend systems are accessed on behalf of the user via interfaces available to front-end applications. Backend systems like those within Enterprise backend environment 145 on secure network 170 are inaccessible to end-users by means other than front-end “client” Enterprise enabled applications and Enterprise widgets or PLMs 130 that are configured to communicate with Enterprise backend environment 145 via Enterprise widget interface 135. Backend systems are maintained by “system administrators” and employ a greater level of security measures than systems directly accessible by end-users. The data they contain is perceived to be of grater value and therefore a security breach of a backend system poses a greater risk to the Enterprise.

Request 150 sent to backend Enterprise server 180 or other backend system is an electronic message that includes data pertaining to input 120 and additional data provided by PLM 130 or Enterprise widget interface 135 describing the operation it seeks to have the backend system execute. The execution of the operation will generally result in additional data from the backend system responsive to input 120. Request 150 may contain any number of message components, examples of which include a portable logic module identifier, a portable logic module type, a portable logic module environment identifier, a portable logic module state, portable logic module permissions, a portable logic module user identifier, portable logic module user credentials, portable logic module encryption keys, and portable logic module content request, and security credentials required to gain access to a backend system. For example, in one embodiment, request 150 includes the identity of PLM 130, a part number taken from input 120 identifying a part in inventory, and a specified operation asking the backend system where the part is located in a warehouse.

Request 150 may further include a user's identity to compare against an authorized user list, and the location of a backend system that houses the inventory data. In some embodiments however, identification of the backend system is delegated to another entity, for example, Enterprise widget interface 135 may request the location of the backend system storing the required data from Enterprise interface server 175, Enterprise data repository 185 or Enterprise database 190. In another embodiment, request 150 includes information describing the operating environment of PLM 130 or Enterprise widget interface 135 for comparison with an authorized environment list.

Response 155 returned to engine 140 or Enterprise widget interface 135 is also an electronic message that includes data pertaining to input 120 and additional information pertaining to the result of the operation solicited by input 120, provided by a backend system, such as Enterprise server 180. Response 155 may include message components including information such as an error message (e.g. a message stating that the user identification provided is invalid or unauthorized, or that the solicited operation could not be performed), portable logic module encryption keys, portable logic module authorization data, portable logic module attribute modifiers, portable logic module state changes, portable logic module input requests, portable logic module relationships, and portable logic module content (e.g. text or graphics), or results of a solicited operation (e.g. results from a database, or calculated results based on information possessed by the backend system). For example, in one embodiment, response 155 includes the location of a part in the warehouse. In another embodiment, response 155 includes the quantity of parts in the warehouse, or ambient temperature of the warehouse as detected by an electronic sensor, or the remaining test time of a system under test in a manufacturing facility as determined by a backend Enterprise system in response to request 150.

In one particular embodiment, engine 140 receives input 120 from an Enterprise widget running on computing device 110. Engine 140 then generates request 150 based on the contents of input 120 received, and transmits request 150 to Enterprise server 180 via secure communication path 160. Engine 140 then receives response 155 from Enterprise server 180 including data related to request 150 sent. Widget runtime environment 129 generates representation 125 of the data received in response 155 and transmits representation 125 to computing device 110 to render representation 125 via computer interface 115.

Representation 125 generated is a set of information that is presented to computing interface 115 for rendering. Representation 125 will include at least data pertaining to the result of the solicited operation, which in turn relates to input 120, be it an error message, data from a backend system within Enterprise backend environment 145, or an updated representation in response to a locally executed operation. For example, in one embodiment a representation includes a text label identifying information relating to a location of a part in a warehouse and further includes the location, such as “row 7, slot A.”

Rendering representation 125 is the process of conveying the information contained within representation 125 to another entity, for example, an end-user. Representations can be rendered via auditory devices such as speakers, displayed via graphical devices such as televisions or computer monitors, shown as typeface on a printed paper or as plain text within a Unix command shell, and so on.

Data object 132 is an individual unit of run-time data storage that may be used as a basic functional element. Data object 132 may be capable of receiving messages, processing data, and sending messages to other data objects. Data objects 132 are objects compatible with object oriented programming (“OOP”) languages or object databases. Many programming languages support data objects, including: Java, JavaScript, C#, Net (pronounced “dot-net”), C++, Python, Perl, PHP, etc.

Data object 132 may include business logic 131 maintained by PLM 130. Similar to attributes 133, business logic 131 may be maintained by PLM 130 inside or outside of data object 132. Business logic 131 may relate to any of a variety of tasks such as vacation monitoring, budget monitoring, work-list monitoring, portable logic module version monitoring, account monitoring, sales opportunity monitoring, sales order status monitoring, conversation monitoring, test monitoring, build of materials (“BOM”) monitoring, inventory monitoring, temperature monitoring, or any other task associated with the duties of an Enterprise employee.

Attributes 133 can store information for PLM 130 and Enterprise widget interface 135. Attributes 133 may be any data, variable, parameter, or other information related to the operation or configuration of PLM 130 or Enterprise widget interface 135. For example, attributes 133 can affect representation 125 of data in PLM 130, the graphical display of PLM 130 itself, the operation of PLM 130 or Enterprise widget interface 135, the characteristics of PLM 130 or Enterprise widget interface, etc. Examples of attributes 133 within PLM 130 include PLM size, PLM position, PLM representation type (e.g. graphical, textual, audible), PLM state, PLM docking mode, PLM interrelationships, and PLM name. Examples of attributes 133 within Enterprise widget interface 135 include default Enterprise interface server 175 name/location, security keys, default encryption methods (e.g. none, strong, weak, etc.), default translators 260-264, default services 266-273, default behavior when errors occur, etc.

In one embodiment, attributes 133 of PLM 130 are configured to maintain device awareness, and PLM 130 via business logic 131 adapts the configuration of attributes 133 to ensure compatibility of PLM 130 with devices connected with PLM 130 via a host computer or other electronic host or interface. For example, in a particular embodiment, business logic 131 configures attribute 133 of PLM 130 to establish and maintain a connection with an electronic smart card reader. In another embodiment, business logic 131 through PLM 130 establishes a connection with a printer, or a wireless broadcasting device capable of controlling remote control items such as security doors, and emergency alarms.

Computing device 110 resides within user accessible network 165, or more particularly, a network that is accessible to Enterprise employees or any other person making use of computing device 110. Enterprise systems 175, 180, 185, and 190 are protected from unauthorized intrusion via secure network 170. Secure network 170 may be of any type understood and practiced in the art of network security. Common security methods are encryption, authentication, firewalls, and challenge/response systems. The portion of secure network 170 that contains the Enterprise systems is Enterprise backend environment 145.

Enterprise backend environment 145 contains Enterprise interface server 175, backend Enterprise server 180, Enterprise data repository 185, and Enterprise database 190. Each Enterprise system within Enterprise backend environment 145 is connected with Enterprise widget interface 135 via secure communication paths 160. Enterprise widget interface 135 may also be connected with Enterprise backend environment 145 via an encrypted communication path.

In accordance with one embodiment, PLM 130 sends request 150 containing input 120 to Enterprise widget interface 135. Input 120 is a solicitation from an Enterprise employee requesting information relating to the Enterprise Employee's paycheck data. Input 120 contains data identifying the Employee's identity and security credentials. PLM 130 need not know the location of the data required to fulfill the solicited operation. Enterprise widget interface 135 receives the request via engine 140 and determines that the data required to fulfill the solicited operation is housed within a human resources Enterprise database 190 system, protected by secure network 170 and other security measures. Enterprise widget interface 135 sends a request to Enterprise database 190 relating to the solicited operation.

In one embodiment, request 150 traverses the security measures of secure network 170 by engaging engine 140 of Enterprise widget interface 135. Enterprise database 190 verifies the authenticity of request 150 by authenticating the Enterprise Employee's security credentials originally supplied via input 120 and further verifies the security credentials of requesting PLM 130 provided from attributes 133 kept by PLM 130 or Enterprise widget interface 135. Backend Enterprise database 190 then processes request 150 and sends back response 155 containing data pertaining to the solicited operation, including the paycheck related data for the Enterprise employee. Response 155 is received at Enterprise widget interface 135 and forwarded back to PLM 130, at which point PLM 130 generates representation 125 of the data relating to the solicited operation, and sends representation 125 to computing device 110 for rendering via computing interface 115.

In another embodiment PLM 130 or Enterprise widget interface 135 need not know the location of the data required to fulfill the solicited operation, but need only know the location of Enterprise interface server 175. Enterprise widget interface 135 forwards request 150 to Enterprise interface server 175 that contains functionality to determine the location of the required data. Enterprise interface server 175 forwards request 150 and receives response 155 and returns response 155 to Enterprise widget interface 135. In one embodiment, Enterprise interface server 175 forwards request 150 to another backend system of Enterprise backend environment 145, but doesn't return response 155, instead the system that fulfills the solicited operation, for example, Enterprise database server 190 returns response 155 directly to Enterprise widget interface 135, based on data contained within request 150 identifying requesting PLM 130 or Enterprise widget interface 135.

In one particular embodiment, Enterprise widget interface 135 contacts Enterprise interface server 175 for the location of an Enterprise system within Enterprise backend environment 145 able to fulfill the solicited operation, but then sends request 150 itself, from Enterprise widget interface 135 to the appropriate Enterprise system, for example, to Enterprise data repository 185, thus bypassing Enterprise interface server 175 for the operation solicitation function.

Enterprise widget interface 135 can supplement a widget runtime environment 129 that has no mechanism to contact Enterprise systems within Enterprise backend environment 145. In one embodiment, Enterprise widget interface 135 functions as a gateway or go-between for engine 140 or widget runtime environment 129, accepting and transporting messages between Enterprise backend environment 145 on secure network 170 and PLMs 130 operating on computing device 110 within user accessible network 165. In another embodiment, widget runtime environment 129, engine 140, and Enterprise widget interface 135 are part of one software application and Enterprise widget interface 135 is a segment of the software application that facilitates communication between Enterprise widgets 130 and Enterprise systems 175-190. In alternative embodiment, widget runtime environment 129 and engine 140 support traditional widgets only. In this embodiment, Enterprise widget interface 135 is installed on computing device 110 as a separate software application and configured to provide communication between Enterprise widgets 130 operating within widget runtime environment 129 that cannot otherwise communicate with secure network 170. In yet another embodiment, Enterprise widget interface 135 is a module within engine 140, thus enabling engine 140 to provide PLMs 130 operating within widget runtime environment 129 access to Enterprise data located within Enterprise backend environment 145.

Enterprise interface server 175 may be part of another Enterprise system within Enterprise backend environment 145. For example, Enterprise server 180, or Enterprise interface server 175 may be instead connected to backend server 180. Each of the Enterprise systems in Enterprise backend environment 145 maintains connections with each other via secure network 170. Enterprise interface server 175 may be hardware based or software executing on a hardware platform. Enterprise data repository 175 may fulfill solicited operations, as may Enterprise server 180, or Enterprise database 190.

Enterprise data repository 185 may be any system that contains data necessary to fulfill solicited operation requested by PLM 130 or Enterprise widget interface 135, or Enterprise interface server 175. In one embodiment, Enterprise data repository 185 is a Lightweight Directory Access Protocol (“LDAP”) compatible system. In another embodiment, Enterprise data repository 185 is a network file server. In yet another embodiment Enterprise data repository 185 is a Sun Microsystems Network File System (“NFS”) compliant data repository hosted by a Unix server.

Enterprise database 190 can be any database capable of fulfilling the operation solicited by PLM 130, Enterprise widget interface 135, or Enterprise interface server 175. For example, in one embodiment, Enterprise database 190 is a Structured Query Language (“SQL”) compatible system. In another embodiment, Enterprise database 190 is a structured database program running on a computer system. In a particular embodiment, Enterprise database 190 is a relational database system.

In a particular embodiment, Enterprise systems 175-190 all reside on a single physical computer system. In another embodiment, Enterprise systems 175-190 are supported by multiple physically distinct computer systems. In yet another embodiment, there are multiple Enterprise servers 175, multiple Enterprise data repositories 185, and multiple Enterprise database systems 190 executing within Enterprise backend environment 145, each capable of fulfilling a solicited operation depending on the type of data requested.

In one embodiment Enterprise widget interface 135 does not know the location of the data it requires to fulfill a solicited operation and must contact Enterprise interface server 175 to determine the source of the data. For example, data required to fulfill the solicited operation resides on Enterprise data repository 185, however, Enterprise widget interface 135 has no knowledge of Enterprise data repository 185, and thus the location of the required data is unknown to Enterprise widget interface 135, but not to Enterprise interface server 175. In another embodiment, Enterprise widget interface 135 knows of at least one location housing the data it requires to fulfill the solicited operation (e.g. Enterprise database 190), but can elect to contact Enterprise interface server 175 or the known location depending on attributes 133 held within Enterprise widget interface 135. In one embodiment, Enterprise widget interface 135 determines when it will use the known location of the data it requires, for example, contacting known Enterprise database server 190, and when it will contact Enterprise interface server 175 to determine the location of the data it requires to fulfill the solicited operation. In a particular embodiment, Enterprise widget interface 135 tests the security credentials held within attributes 133 of PLM 130 to determine if the required data is accessible from a known location, and when they are not, it forwards request 150 and the security credentials to Enterprise interface server 175 to identify a location of an Enterprise system within Enterprise backend environment 145 that can fulfill the solicited operation.

In another embodiment, Enterprise widget interface 135 solicits the required data from both a known location and from an unknown location via Enterprise interface server 175, and elects which of received responses 155 to base representation 125 on. In an alternative embodiment, Enterprise widget interface 135 solicits the required data from both a known location and from an unknown location via Enterprise interface server 175, and uses response 155 received back first. In yet another embodiment, Enterprise widget interface 135 solicits the required data from both a known location and from an unknown location Enterprise interface server 175, and elects which of received responses 155 to use based upon a date or timestamp associated with the data in response 155. In an alternative embodiment, Enterprise widget interface 135 upon receiving more than one response 155 having related but inconsistent data, generates representation 125 that depicts the data from the multiple responses 155. For example, representation 125 may include extrapolated data calculated from the multiple results, or representation 125 may depict more than one data result and identify the multiple data sources within representation 125.

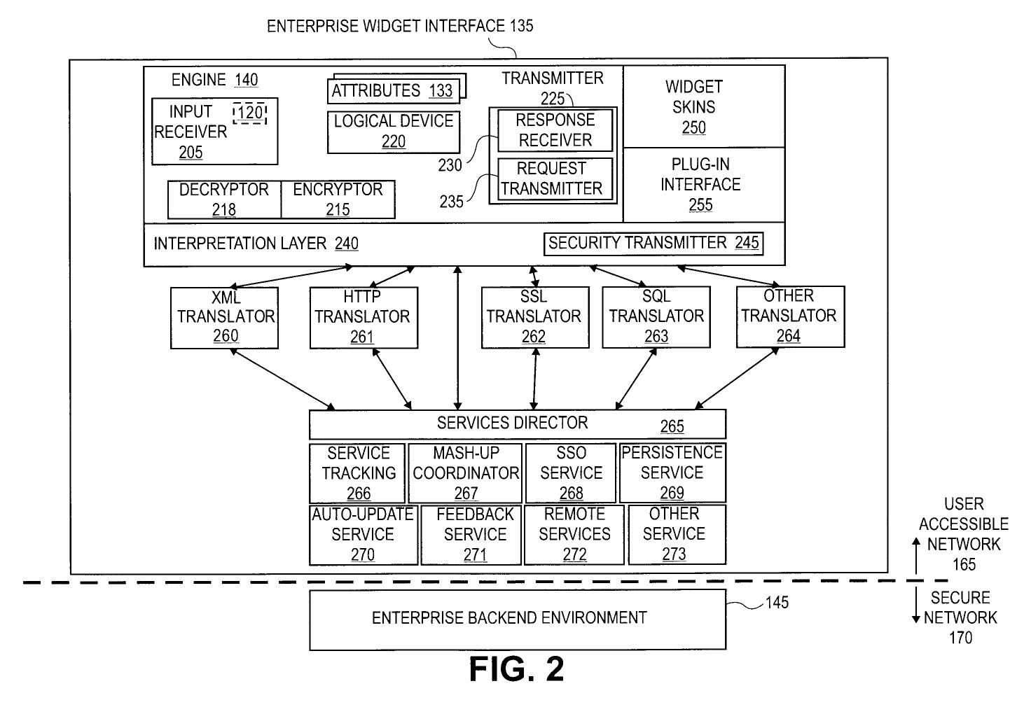

Refer now to FIG. 2 illustrating Enterprise widget interface 135 configured to transmit information between an Enterprise widget 130 and backend Enterprise server 180 according to a particular embodiment.

Widget runtime environment 135 contains engine 140 which in turn contains input receiver 205 to receive input 120 from an Enterprise widget or PLM 130, logic device 220 to execute logical instructions, such as computer software or firmware, encryptor 215 to encrypt requests prior to their transmission on secure communication path 160 or to encrypt the communicated transmission itself over secure communication path 160, and decryptor 210 to decrypt responses received from Enterprise systems in Enterprise backend environment 145. Engine 140 further contains transmitter 225 to transmit and receive requests 150 and responses 155 via secure communication path 160.

Engine 140 finally contains attributes 133 to store configuration data or information pertaining to Enterprise widget interface 135 in memory locations or hardware registers. In one embodiment, attributes 133 of PLM 130 or Enterprise widget interface 135 are configured to maintain computer state sensitivity. Examples of computer state sensitivity include awareness by PLM 130 or Enterprise widget interface 135 through attributes 133 that the state of a computer is presently “on-line” or presently maintains an active connection with the Internet. In another embodiment, computer state sensitivity is awareness that computing device 110 is outside of a firewall, and thus requires additional security credentials.

In yet another embodiment, Enterprise widget interface 135 via computer state sensitivity is aware of the identity of the user accessing PLM 130 and at least a portion of the security credentials employed by the user to access a computer hosting PLM 130. In a particular embodiment, computer state sensitivity may gain at least a portion of its awareness, represented in attributes 133 through a connection with the location manager on Apple Macintosh™ based systems, the network connection profile on Windows™ based systems, or via equivalent functionality on Linux™ based systems or other variants.

Enterprise widget interface 135 is capable of generating and encrypting request 150 via engine 140 and encryptor 215 and decrypting response 155 via decryptor 210. PLM 130 is further capable of communication with Enterprise systems via an encrypted communication path connected with Enterprise widget interface 135. In one embodiment, Enterprise widget interface 135 encrypts request 150 creating an encrypted request and transmits the encrypted request to Enterprise server 180 via secure communication path 160, at which point Enterprise server 180 must decrypt the encrypted request, creating a decrypted request. The decrypted request and request 150 are identical to each other after decryption. The type of encryption used between Enterprise widget interface 135 and backend server 105 may be of any type understood and practiced in the computing arts.

Encryption refers to the use of cryptography or other means to scramble or obscure information in such a way that it cannot be retrieved without having special knowledge, such as a “secret” or a “key.” Decryption is the act of unscrambling or un-encrypting information previously encrypted so that it may be understood. The use of special processes or “secrets” are generally required to view information protected by means of encryption. An encrypted communication path is a means for transmitting information where the communication signal is encrypted, rather than the content placed onto the communication signal, although an encrypted communication path can transmit encrypted content as well. Encryption, decryption, and encrypted communication paths are well understood in the art of computer security and will not be defined further.

FIG. 2 further illustrates interpretation layer 240 to interface with various translators capable of converting one data format to another. Interpretation layer 240 may optionally include security transmitter 245 to securely transmit information via secure communication path 160 in addition to or in place of transmitter 225.

Through interpretation layer 240, Enterprise widget interface 135 can access various optional services provided by other applications or more sophisticated features not available through Enterprise widgets or PLMs 130 themselves. For example, Extended markup language (“XML”) translator 260 provides XML translation services to Enterprise widget interface 135 and portable logic modules 130 or Enterprise widgets in communication with Enterprise widget interface 135. XML translator 260 is enabled to convert data and instructions coming from Enterprise widget interface 135 or portable logic modules 130, in a native format into XML that is compatible with external services. Some portable logic modules 130 may use XML themselves, requiring little or no conversion, while others may employ an incompatible data format or structure.

Hyper-text transfer protocol (“HTTP”) translator 261, secure sockets layer (“SSL”) translator 262, structured query language (“SQL”) translator 263, and “other” translator 264 likewise perform similar functions. Each converts foreign data originating outside of translators 260 to 264 either from or to its native language/protocol. For example, in one embodiment, portable logic modules 130 are not equipped with SSL capability, but data transmitted between PLMs 130 and other services via Enterprise widget interface 135 must be in such a format. Without adding to the complexity of PLMs 130, SSL translator 262 fulfills this requirement. Similarly, in another embodiment, data going to or being returned from an SQL database must be in a syntactically correct format.

Ensuring proper syntactical formatting requires a significant amount of complexity and business logic or “code,” however, SQL translator 263 provides this service for PLMs 130 and Enterprise widgets without adding to the complexity of PLMs 130 or Enterprise widgets themselves. PLMs 130 only need to be able to communication with SQL translator 263 or any of the other translators 260 to 264 via Enterprise widget interface 135. The translator labeled as “other” translator 264 is meant to illustrate that additional translators 260 to 264 may be added without introducing additional complexity and code to PLMs 130, or indeed even modifying PLMs 130 themselves.

In one embodiment, PLMs 130 need not be aware of additional services such as translators 260 to 264 or other functional services 266 to 273. This helps to ensure PLMs 130 remain simplistic relative to full-feature applications, not having the complexity or need for continual updates and modifications common in full-feature applications. In this embodiment, PLMs 130 communicate only with Enterprise widget interface 135 to access additional services 260 to 264 and 266-273. Enterprise widget interface 135 then relays the request to the appropriate service either through an appropriate translator 260 to 264, through services director 265, or to a functional service component directly 266 to 273, depending on the configuration of Enterprise widget interface 135.

Enterprise widget interface 135 may operate with only a single connection to multiple Enterprise widgets 130, fulfilling requests from the multiple Enterprise widgets 130 by requesting and receiving information from multiple Enterprise systems 175-190. For example, in one embodiment, widget runtime environment 129 hosts four Enterprise widgets 130. Each Enterprise widget 130 sends input 120 to Enterprise widget interface 135 soliciting information or operations of backend Enterprise systems 175-190, and each Enterprise widget 130 requests information from a different Enterprise system 175-190. Enterprise widget interface 135 functions as a multiplexing gateway, coordinating the multiple inputs 120 from Enterprise widgets 130, retrieving or requesting information from the appropriate Enterprise system 175-190 on behalf of each Enterprise widget 130, and sending an appropriate response 155 to each Enterprise widget 130 based upon the result of each Enterprise widget's solicited operation. In other embodiments, a single Enterprise widget interface 135 services multiple widget runtime environments 129, each having multiple PLMs 130. In different embodiments, each widget runtime environment 129 is uniquely associated with one Enterprise widget interface 135, possibly resulting in multiple Enterprise widget interfaces 135 on a single computing device 110.

In addition to translators 260-264 described above, Enterprise widget interface 135 may optionally include services director 265 connected with multiple services such as service tracking module 266, mash-up coordinator 267, single sign on (“SSO”) service 268 provider, persistence service 269, auto-update service 270, feedback service 271, remote services 272 provider, and a service module labeled as “other service” 273 intended to represent any other service module desired to be added without having to modify the structure illustrated or add unnecessary complexity to PLMs 130 themselves.

Service tracking module 266 can provide a list of available services that are in communication with Enterprise widget interface 135, PLMs 130, or services director 265 by any means. Mash-up coordinator 267 can coordinate communication between various services 266-273, joining the functionality of the respective services without adding complexity or functionality to PLMs 130. SSO service 268, alternatively referred to as a “service mediator,” reduces the authentication logic and required security data of PLMs 130 that make requests through Enterprise widget interface 135, or through services director 265. In one embodiment, requests destined for Enterprise server 180 within Enterprise backend environment 145 are routed through SSO service 268. SSO service 268 injects additional authentication data, security information, or security credentials into request 150 so that request 150 can traverse through secured Enterprise backend environment 145 to Enterprise server 180. This reduces the complexity of requesting PLM 130.

Persistence service 269 provides data persistence capabilities to PLM 130 without adding additional complexity to requesting PLM 130 itself. Auto-update service 170 enables PLMs, Enterprise widget interface 135, service director 265, or any other service 266-273 to check for and receive updates from a remote source without adding complexity to the requestor. Feedback service 271 allows requesting PLMs 130, services 266-273, or other components to provide usage statistics, diagnostic information, and other feedback to a remote destination. Remote services 272 provider enables services director 265, Enterprise widget interface 135, or PLMs 130 to interface with additional services that Enterprise widget interface 135 may not be aware of until a specific request or query is made through remote services 272 provider.

In one embodiment, Enterprise widget interface 135 has widget skins component 250 and plug-in interface 255. Widget skins component 250 allows “skins” or alternative graphical overlays to be applied to PLMs 130, without PLMs 130 themselves being aware of the change in their graphical appearance or other representation 125. The widget skins may be provided with Enterprise widget interface 135, widget skins component 250, widget runtime environment 129, computing device 110, operating system 112, or downloaded via the Internet.

Plug-in interface 255 enables Enterprise widget interface 135 to incorporate additional functionality configured as a plug-in, similar to web-browser plug-ins. Plug-in interface 255 may be used to incorporate functionality that cannot be provided as a service component 266-273 integrated with Enterprise widget interface 135. Alternatively, plug-in interface 255 allows the mash-up of different services via incorporation of plug-ins, without having to code all the service functionality into Enterprise widget interface 135.

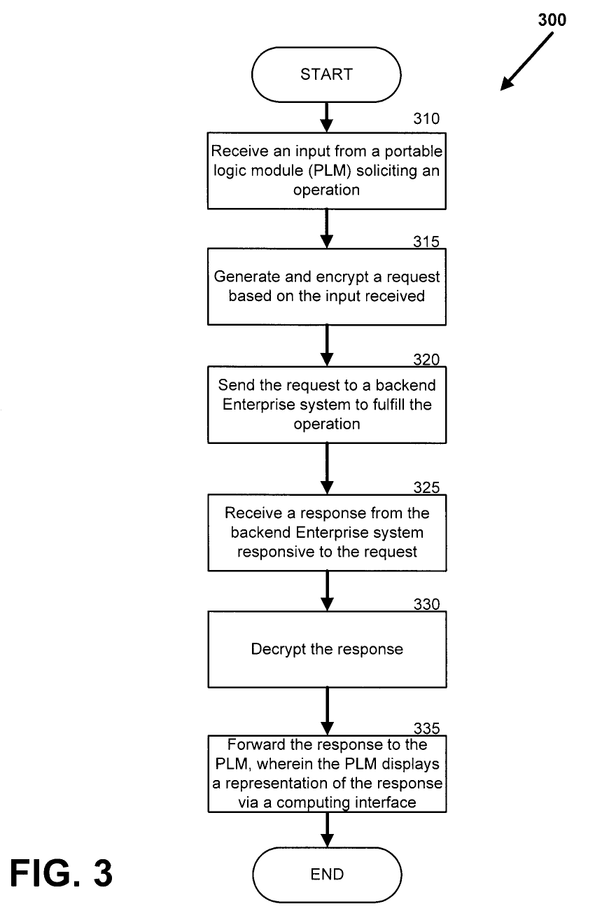

Refer now to FIG. 3 illustrating method 300 at Enterprise widget interface 135 to receive input 120 from portable logic module 130, send and receive information from a backend Enterprise system, and forward information back to portable logic module 130 responsive to input 120 according to a particular embodiment. Other embodiments may have additional or fewer elements, and can be represented in alternate sequences.

In one embodiment, Enterprise widget interface 135 receives input 120 from a portable logic module, widget, or enterprise widget (e.g. PLM 130), where input 120 is soliciting an operation from Enterprise widget interface 135, such as a data request from a backend Enterprise system (block 310). At block 315, Enterprise widget interface 135 generates and encrypts request 150 based on input 120 received at block 310. At block 320, Enterprise widget interface 135 sends request 150 to a backend Enterprise system (e.g. Enterprise server 180) requesting the backend Enterprise system fulfill the operation solicited by input 120. At block 325, Enterprise widget interface 135 receives response 155 from the backend Enterprise system in response to request 150. At block 330, Enterprise widget interface 135 decrypts response 155 (e.g. applies a decryption key and algorithm against response 155 via an encryption chip) resulting in a decrypted response 155. At block 335, Enterprise widget interface 135 forwards decrypted response 155 back to PLM 130. PLM 130 displays a representation of response 155 via computing interface 115 (e.g. a graphical representation of Enterprise widget 130 displays text within the Enterprise widget on a computer monitor).

Parts or elements of the present invention may be implemented in hardware, firmware, software, or in combination. For example, in one embodiment, attributes 133 are maintained in hardware via registers on a printed circuit board (“PCB”). In an alternative embodiment, attributes 133 are maintained entirely by software as virtual locations in a computer memory. In yet another embodiment, a combination of firmware, hardware and software are used to maintain attributes 133 stored on a hard disk drive, and the physical storage is controlled by the hard disk drive's firmware and the values of attribute 133 are controlled by software. Furthermore, components of the present invention may be combined or segmented into additional parts and maintain harmony within the spirit of the invention. For example, the input receiver of Enterprise widget interface 135 may be combined with the request receiver in accordance with the present invention. In an alternative embodiment, the response receiver may be broken down into a receiving component, a separate decryption component, and a component to communicate via an encrypted communication path.

Parts or elements of the invention may also be stored as instructions on a machine readable medium, computer readable medium, or storage medium (e.g. hard disk drives, floppy disks, compact disks (CD-ROM disks), digital versatile disks (DVDs), solid state flash drives, computer memory (RAM), network file servers, internet protocol (IP) packets read via a wired or wireless network connection, etc. In one embodiment, computing device 110 has a hard disk drive with software (e.g. computer instructions) stored on it. Computing hardware 111 of computing device 110 includes a central processing unit (“CPU”) to execute instructions including the software stored on the hard disk drive and instructions associated with operating system 112. In this embodiment, the CPU loads the instructions from the hard disk drive into random access memory (RAM) and executes them. When executed, the processor performs operations including receiving input 120 at Enterprise widget interface 135 from portable logic module 130. Input 120 includes information soliciting an operation from a backend server. Enterprise widget interface 135 sends request 150 to the backend server to execute the solicited operation, receives response 155 which includes data relating to the operation executed by the backend server, and sends response 155 to portable logic module 130 for rendering by computing interface 115. In another embodiment, the processor reads and executes instructions to perform encryption and decryption operations on communications passed between Enterprise widget interface 135 and Enterprise backend systems.

Thus, method 300, apparatus 100, and Enterprise widget interface 135 for communicating information between portable logic modules and backend Enterprise systems within Enterprise backend environment 145 has been disclosed. Enabling portable logic module 130 to communicate with backend computer systems may result in improved utility for Enterprise employees requiring access to Enterprise data, or to other users who have access to portable logic modules 130 enabled to access secure data from secure environments and secure networks 170. The use of portable logic modules 130, as opposed to traditional feature rich applications may allow a user to combine together Enterprise widgets or PLMs 130 to create customized environments that include only portable logic modules 130 having functionality that the user requires. A further benefit may be to the Enterprise itself and Enterprise software developers through reduced development costs, and improved user satisfaction through the lack of unnecessary features resulting in unnecessary complexity, and the presence of desired features, many of which may be impractical to provide otherwise. It should be understood that although the details of the various embodiments disclosed herein are with respect to one Enterprise widget interface 135 and computing device 110, more than one Enterprise widget interface 135 and computing device 110 may be used contemporaneously and are considered part of the present invention.

What is claimed is:

1. An Enterprise widget interface accessible via a computing device comprising:
a receiver to receive an input from a widget runtime environment, the input to solicit an operation of a backend server separate from the computing device;
a request transmitter to send a request from the Enterprise widget interface to the backend server to execute the operation;
a response receiver to receive a response from the backend server, the response to include data related to the execution of the operation; and
a generator to generate a representation of the response, the representation to be displayed at the widget runtime environment via a computing interface connected with the computing device.

2. The Enterprise widget interface of claim 1, further comprising:
a security transmitter to receive the request from the request transmitter, encrypt the request, and transmit the request to the backend server via a secure communication path.

3. The Enterprise widget of claim 1, further comprising:
an encryptor to encrypt the request before the request is sent to the backend server; and
a decryptor to decrypt the response after the response is received from the backend server.

4. The Enterprise widget interface of claim 1, wherein the input from the widget runtime environment to originate at an Enterprise widget to execute within the widget runtime environment.

5. The Enterprise widget interface of claim 1, wherein the input from the widget runtime environment to be received from a widget engine within the widget runtime environment, the widget engine to support the execution of one or more widgets.

6. The Enterprise widget interface of claim 1, wherein the representation to be displayed at the widget runtime environment via the computing interface comprises the widget runtime environment to display the representation in association with an Enterprise widget operating within the widget runtime environment.

7. The Enterprise widget interface of claim 1, further comprising at least one of: an Extended Markup Language (“XML”) translator to provide XML translation services to the Enterprise widget interface;
a Hyper-text transfer protocol (“HTTP”) translator to provide HTML translation services;
a Secure Sockets Layer (“SSL”) translator to provide SSL translation services; and
a Structured Query Language (“SQL”) translator to provide SQL translation services.

8. The Enterprise widget interface of claim 1, further comprising at least one service module selected from the group comprising:
a service tracking module to provide a list of available service modules accessible from the Enterprise widget interface;
a mash-up coordinator service module to coordinate communication between all available service modules and to join the functionality of the respective service modules;
a Single Sign On (“SSO”) service module to offload authentication security responsibilities from the Enterprise widget interface;
a persistence service module to provide data persistence functionality for Enterprise widgets connected with the Enterprise widget interface;
an auto-update service module to check for and receive updates from a remote source on behalf of the Enterprise widget interface and all connected widgets;
a feedback service module to provide usage statistics and diagnostic information to a remote destination on behalf of the Enterprise widget interface; and
a remote services module to connect the Enterprise widget interface with remove services not locally available at the computing interface.

9. The Enterprise widget interface of claim 1, further comprising at least one of:
a widget skins interface to enable the Enterprise widget interface to represent supplemental graphical overlays onto widgets connected with the Enterprise widget interface;
a plug-in interface to connect with supplemental plug-in modules;
an interpretation layer to connect the Enterprise widget interface with translators that convert data formats; and
a services director to connect the Enterprise widget interface with supplemental service modules.

10. A method in a computing device comprising:
receiving at an Enterprise widget interface within the computing device, an input from a portable logic module, the input soliciting an operation of a backend server separate from the computing device;
sending a request from the Enterprise widget interface to the backend server to execute the operation;
receiving at the Enterprise widget interface, a response from the backend server, the response including data related to the execution of the operation; and
sending the response from the Enterprise widget interface to the portable logic module for rendering by a computing interface connected with the computing device.

11. The method of claim 10, wherein the portable logic module is an Enterprise widget.

12. The method of claim 10, wherein the backend server operates on a secure network, the method further comprising:
negotiating at the Enterprise widget interface, a secure connection with the backend server via the secure network.

13. The method of claim 10, wherein sending the request from the Enterprise widget interface to the backend server comprises:
encrypting the request at the Enterprise widget interface; and
transmitting the encrypted request to the backend server via the secure network.

14. The method of claim 10, wherein sending the request from the Enterprise widget interface to the backend server comprises:
encoding the request on an encrypted transmission signal and;
transmitting the encrypted transmission signal to the backend server via the secure network.

15. The method of claim 10, wherein receiving at the Enterprise widget interface, the response from the backend server comprises:
receiving an encrypted response from the backend server; and
decrypting the response.

16. The method of claim 10, further comprising:
determining a communication path to the backend server.

17. The method of claim 16, wherein determining the communication path to the backend server comprises at least one of:
reading a portable logic module attribute specifying the communication path;
reading an Enterprise widget interface attribute specifying the communication path;
requesting the communication path from a backend data repository;
requesting the communication path from a backend database; and
requesting the communication path from an Enterprise widget interface server.

18. The method of claim 10, wherein the request includes a plurality of message components, wherein each message component is selected from a group of message components including a portable logic module identifier, a portable logic module type, a portable logic module environment identifier, a portable logic module state, portable logic module permissions, a portable logic module user identifier, portable logic module user credentials, portable logic module encryption keys, and portable logic module content request, or a combination thereof.

19. The method of claim 10, wherein the response includes a plurality of message components, wherein each message component is selected from a group of message components including portable logic module encryption keys, portable logic module authorization data, portable logic module attribute modifiers, portable logic module state changes, portable logic module input requests, portable logic module relationships, and portable logic module content, or a combination thereof.

20. A computing device comprising a machine-readable medium having instructions stored thereon that, when executed by a processor, cause the processor to perform operations comprising:
receiving at an Enterprise widget interface within the computing device, an input from a portable logic module, the input soliciting an operation of a backend server separate from the computing device;
sending a request from the Enterprise widget interface to the backend server to execute the operation;
receiving at the Enterprise widget interface, a response from the backend server, the response including data related to the execution of the operation; and
sending the response from the Enterprise widget interface to the portable logic module for rendering by a computing interface connected with the computing device.

21. The computing device of claim 20, wherein the portable logic module is an Enterprise widget.

22. The computing device of claim 20, wherein the backend server operates on a secure network, and wherein the instructions cause the processor to perform further operations comprising:
negotiating, at the Enterprise widget interface, a secure connection with the backend server via the secure network.

23. The computing device of claim 20, wherein sending the request from the Enterprise widget interface to the backend server comprises:
encrypting the request at the Enterprise widget interface; and
transmitting the encrypted request to the backend server via the secure network.

24. The computing device of claim 20, wherein the instructions cause the processor to perform further operations comprising:
determining a communication path to the backend server, wherein determining the communication path to the backend server comprises at least one of:
reading a portable logic module attribute specifying the communication path;
reading an Enterprise widget interface attribute specifying the communication path;
requesting the communication path from a backend data repository;
requesting the communication path from a backend database; and
requesting the communication path from an Enterprise widget interface server.
